(19) United States
(12) Patent Application Publication
(10) Pub. No.: US 2013/0276039 A1
(43) Pub. Date: Oct. 17, 2013

(54) CHARACTERISTIC KARAOKE VOD SYSTEM AND OPERATING PROCESS THEREOF

(71) Applicants: TSE - MING CHANG, Taipei (TW); Shih- Chia Cheng, Taipei (TW); Kai-Yin Cheng, Taipei (TW)

(72) Inventors: TSE - MING CHANG, Taipei (TW); Shih- Chia Cheng, Taipei (TW); Kai-Yin Cheng, Taipei (TW)

(73) Assignee: IKALA Interactive Media Inc., Taipei City (TW)

(21) Appl. No.: 13/523,810

(22) Filed: Jun. 14, 2012

(30) Foreign Application Priority Data
Apr. 16, 2012 (TW) 101113511

(51) Int. Cl. H04N 21/232; H04N 21/437

(52) U.S. Cl. 725/92

(57) ABSTRACT

A characteristic karaoke video-on-demand (VOD) system with a reference index database is provided. According to the reference index database as well as a song request signal inputted by a user, the characteristic karaoke VOD system is able to recommend at least one artist or at least one song to the user to enhance convenience and functionality offered by the characteristic karaoke VOD system.

### BACKGROUND OF THE INVENTION

1. Field of the Invention

The invention relates in general to a karaoke video-on-demand (VOD) system, and more particularly to a characteristic karaoke VOD system and an operating process thereof.

2. Description of the Related Art

In a current karaoke VOD system, a desired song can only be found with a known artist or song name. Assuming that a user only knows other information associated with the desired song, e.g., an artist genre, a choral artist, a choral song and released albums, the desired artist or the desired song, instead of being found according to the associated information, can still only be found by browsing one song after another. Such process is not only time consuming but also causes inconvenience for the user in searching for the desired song.

### SUMMARY OF THE INVENTION

A characteristic karaoke VOD system is provided according to one embodiment of the present invention. The characteristic karaoke VOD system comprises a remote server and a client server. For example, the client server is a network-connectable device such as a network television, a set-up-box network television, a smart phone or a personal computer. The remote server comprises a reference index database. The reference index database stores associated information of a recommendation table of at least one artist or at least one song having at least one reference index relationship with an artist or a song, so that the characteristic karaoke VOD system is able to recommend the at least one artist or the at least one song to the user according to the at least one reference index. The server further comprises a synonym database. The synonym database offers comparisons of similar words that can be set according to different utilizing habits of the user to optimize convenience of searching as well as system functionality.

An operating process of a characteristic karaoke VOD system is further provided according to another embodiment of the present invention. The process comprises the following steps. A user enters the characteristic karaoke VOD system and inputs a song request signal. The characteristic karaoke VOD system first lists at least one name of an artist or at least one name of song matching the song request signal, and then lists a recommendation table of the at least one artist or the at least one song having at least one reference index relationship with the at least one artist or the at least one song. The user may then proceed with another search or request a song according to the recommendation table.

Therefore, with the characteristic karaoke VOD system and the operating method thereof, according to a song request signal inputted by a user as well as at least one reference index and a synonym database, a customized recommendation table is offered to the user to allow the user to quickly select at least one artist or at least one song listed in the recommendation table according to the at least one reference index. Without knowing an exact artist or song name, the characteristic karaoke VOD system and the operating method thereof of the present invention are capable of searching and finding a desired song or artist, thereby significantly increasing convenience and functionality of the characteristic karaoke VOD system.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a characteristic karaoke VOD system according to one embodiment of the present invention.

FIG. 2 is a block diagram of a user database according to one embodiment of the present invention.

FIG. 3 is a block diagram of an artist reference index according to one embodiment of the present invention.

FIG. 4 is a block diagram of a song reference index according to one embodiment of the present invention.

FIG. 5 is a flowchart of an operating process of a characteristic karaoke VOD system according to one embodiment of the present invention.

FIG. 6 is a flowchart of an operating process of a characteristic karaoke VOD system according to an alternative embodiment of the present invention.

### DETAILED DESCRIPTION OF THE INVENTION

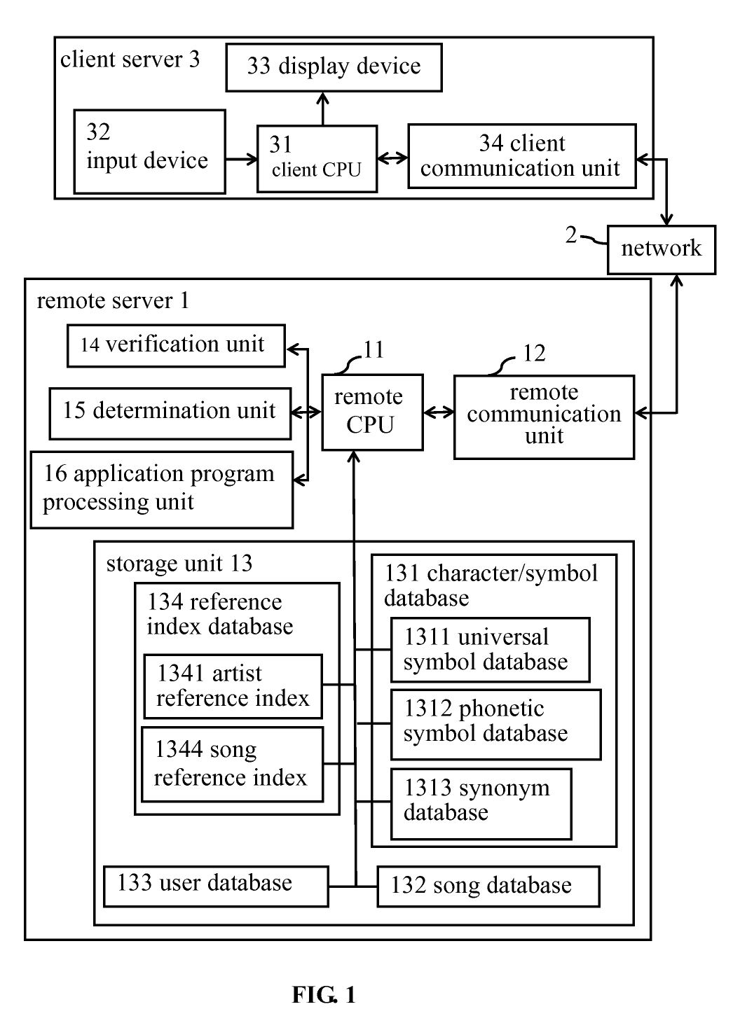

FIG. 1 shows a block diagram of a characteristic karaoke VOD system according to one embodiment of the present invention. The characteristic karaoke VOD system comprises a remote server 1, a network 2 and a client server 3. For example, the client server 3 is a network-connectable device such as a network television, a set-up-box network television, a smart phone or a personal computer.

The remote server 1 comprises a remote central processing unit (CPU) 11, a remote communication unit 12, a storage unit 13, a verification unit 14, a determination unit 15 and an application program processing unit 16.

The remote CPU 11 controls and processes a song request signal transmitted from the client server 3. For example, the song request signal is at least one phonetic symbol or at least one universal symbol. The remote communication unit 12 is connected to the remote CPU 11 via network 2 and serves as a data transceiving and communication interface. The remote server 1 connects to the client server 3 by the remote communication unit 12 via the network 2. The verification unit 14 is connected to the remote CPU 11. As a user chooses to log in the characteristic karaoke VOD system, the verification unit 14 compares the log-in information entered by the user to verify identification of the logged user. The determination unit 15 is connected to the remote CPU 11, and in real-time determines and searches content inputted by the song request signal when the user enters the song request signal. The application program processing unit 16 is connected to the remote CPU 11, and performs a corresponding operation according to the song request signal and transmits an image signal of the performed operation back to the client server 3 for output.

The storage unit 13 comprises a character/symbol database 131, a song database 132, a client database 133 and a reference index database 134, and is connected to the remote CPU 11.

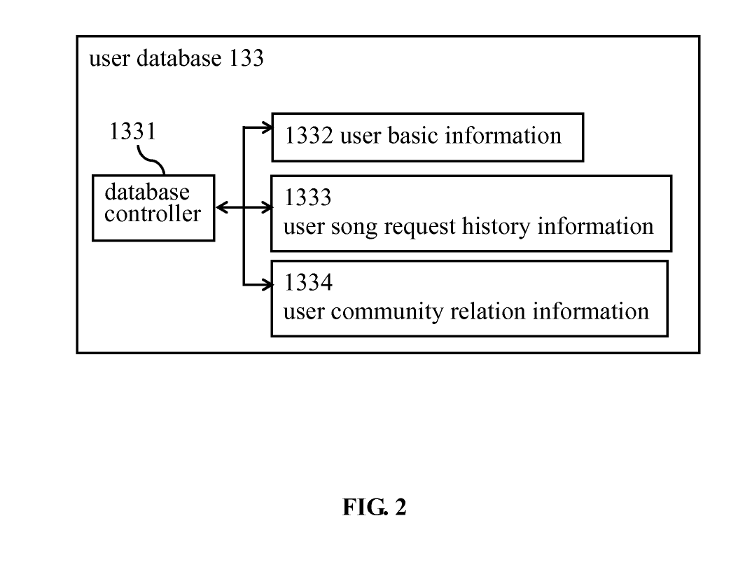

The character/symbol database 131 comprises a universal symbol database 1311, a phonetic symbol database 1312 and a synonym database 1313. The universal symbol database 1311 stores traditional Chinese, simplified Chinese, English alphabet, Japanese hiragana, Japanese katakana, Korean, Roman symbols . . . etc. The synonym database 1313 stores words having similar meanings. The user is also allowed to define a meaning of a particular word in the synonym database 1313 to increase search convenience. When inputting the song request signal, the determination unit 15 compares at least one phonetic symbol or at least one universal character inputted with the character/symbol database 131, and finds at least one similar artist or song name according to a comparison result. The song database 132 stores associated information of the at least one song for search or playback. The user database 133 comprises a database controller 1331 serving as a control and a transceiving interface. The database controller 1331 is connected to user basic information 1332, user song request history information 1333, user community relation information 1334 and the remote CPU 11, as shown in FIG. 2. The user basic information 1332 stores user identification verification and basic information, according to which the verification unit 14 compares the user log-in information to verify whether the user identification is correct. The user song request history information 1333 stores at least one song that is previously requested by the at least one user for accordingly providing a recommendation table. The user community relation information 1334 stores a relationship between the logged-in user and at least one of other users, and records the extent of interaction between the logged-in user and the at least one of other users, so as to allow the characteristic karaoke VOD system to provide the recommendation table.

The reference index database 134 stores associated information having at least one reference index relationship with the at least one artist and the at least one song. The reference index database 134 comprises an artist reference index 1341 and a song reference index 1344, and is connected to the remote CPU 11. When a user inputs a song request signal, the signal transmits from client 3 to determination unit 15 through network 2 and remote CPU 11. The determination unit 15 decides where it can search the similar or matched information stored either in artist reference index 1341 or song reference index 1344 of the reference index database 134. The similar or matched information can be searched and listed and then transmitted to application program processing unit 16 through remote CPU 11. The application program processing unit 16 decides how the searched and listed information will be presented. And then the information processed by application program processing unit 16 is transmitted back to client server 3 through remote CPU 11, remote communication unit 12 and network 2.

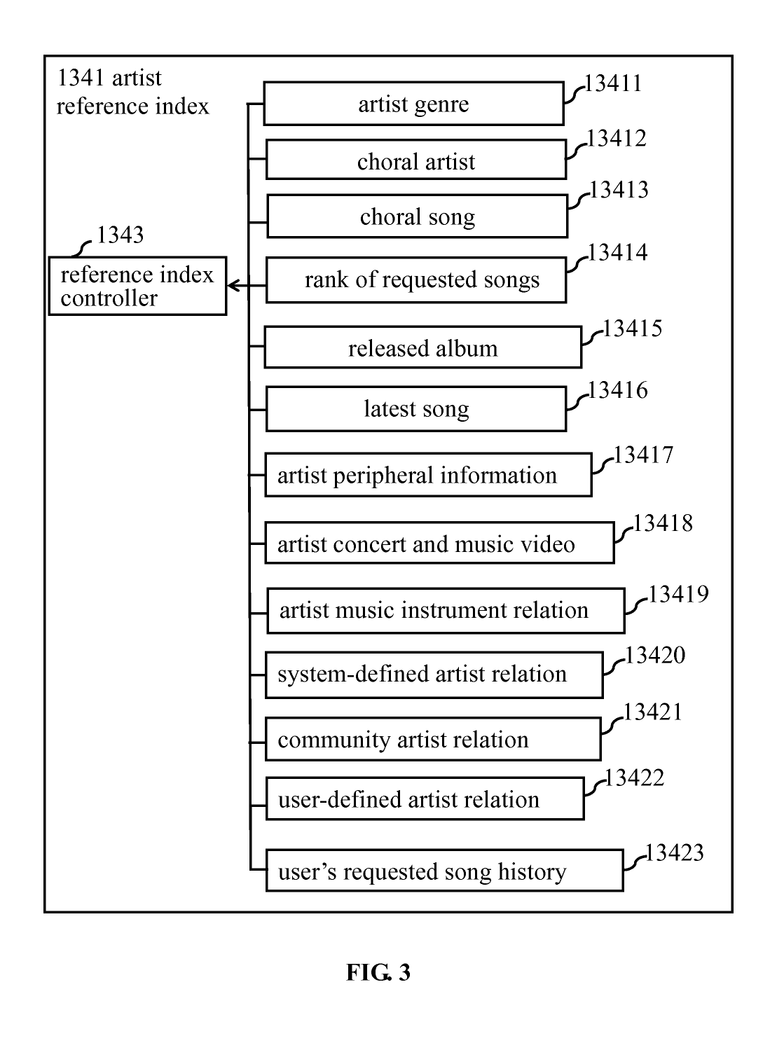

Referring to FIG. 3, the artist reference index 1341 comprises a reference index controller 1343, an artist genre 13411, a choral artist 13412, a choral song 13413, a rank of requested songs 13414, a released album 13415, a latest song 13416, artist peripheral information 13417, an artist concert and music video 13418, an artist music instrument relation 13419, a system-defined artist relation 13420, a community artist relation 13421, a user-defined artist relation 13422 and a user's requested song history 13423. The reference index controller 1343 serves as a control and transceiving interface, and is connected to the remote CPU 11, as well as the artist genre 13411, the choral artist 13412, the choral song 13413, the rank of requested songs 13414, the released album 13415, the latest song 13416, the artist peripheral information 13417, the artist concert and music video 13418, the artist music instrument relation 13419, the system-defined artist relation 13420, the community artist relation 13421, the user-defined artist relation 13422 and the user's requested song history 13423.

The artist genre 13411 stores artists' information of a same gender, a same song genre, or a same type of look. For example, when the user inputs “Country Artist A” as the song request signal at the client server 3, the requested signal is transmitted to the remote communication unit 12 through the network 2. And then it is transmitted to the determination unit 15 through the remote CPU 11. Afterward, the determination unit 15 makes the decision of searching the information of other similar or matched “Country Artists” with Country Artist A in the artist genre 13411 through remote CPU 11. The similar or matched information of Country Artist B, Country Artist C, and Country Artist D could be searched and listed. The searched and listed information is transmitted back to the application program processing unit 16 through the reference index controller 1343 and the remote CPU 11. The application program processing unit 16 decides the list of Country Artist B, Country Artist C, and Country Artist D will be presented into a table. The recommended table of similar or matched information of Country Artist B, Country Artist C, and Country Artist D is transmitted to the client server 3 through the remote CPU 11, the remote communication unit 12 and the network 2. The user could choose the desired “Country Artist” in the table. The way how to present the searched and listed information decided by the application program processing unit 16 could be any other forms. The choral artist 13412 stores the artists' information about artists who have sung one song together. When the user inputs “Artist A” as the song request signal, the song request signal is transmitted to the determination unit 15. The determination unit 15 makes the decision of searching the similar or matched information stored in the choral artist 13412. Other artists who have performed a song with Artist A could be searched and listed. The searched and listed information is transmitted back to the application program processing unit 16. The application program processing unit 16 decides the list of the result will be presented into a table. The recommended table is transmitted to the client server 3 and seen by the user. The information about songs which has been performed by more than one artist is stored in the choral song 13413. When the user inputs “Artist B”, the song request signal is transmitted to the determination unit 15. The determination unit 15 makes the decision of searching the similar or matched information stored in the choral song 13413. The songs which have been performed by Artist B together with other Artists could be searched and listed. The searched and listed information then is transmitted to the client server 3. The information about most frequently requested songs which have been performed by the artist with years in the characteristic karaoke VOD system is stored and particularly listed the most frequently requested one from the top, in the rank of requested songs 13414. When the user inputs “Artist C”, the determination unit 15 makes the decision of searching the songs performed by “Artist C” stored in the rank of requested songs 13414. The matched songs are listed in an order of requested times and the most frequently requested song is listed from the top. The result of list is transmitted to the client server 3. The information about songs in albums performed by the artist is stored in the released album 13415. The information of songs is listed with the released date of albums. When the user inputs “Artist D”, the determination unit 15 makes the decision of searching the songs in the albums performed by “Artist D” stored in the released album 13415. The result of songs' information is listed in an order of released date of the albums. The result of list is transmitted to the client server 3. The information about songs which are performed by the artists is stored in the latest song 13416. The information of songs of the artists is listed with the most recently released songs listed from the top. When the user inputs “Artist E”, the determination unit 15 makes the decision of searching the songs performed by “Artist E” and listed with the most recently released song from the top in the latest song 13416. The result of list is transmitted to the client server 3. The peripheral information about the artists involving in products, brands, activities, programs and movies is stored in the artist peripheral information 13417. When the user inputs a song request signal, the determination unit 15 makes the decision of searching the any peripheral information of Artists relating to the song request signal in the artist peripheral information 13417. The result of the Artists list is then transmitted to the client server 3. The information about songs performed by the artists in concerts and music videos is stored in the artist concert and music video 13418. When the user inputs “Artist F”, the determination unit 15 makes the decision of searching the information about the songs which have performed by “Artist F” in any concerts and music videos in the concert and music video 13418. The result is then transmitted to the client server 3. The information of instruments which are played by the artists is stored in the artist music instrument relation 13419. When a user inputs “piano”, the determination unit 15 makes the decision of searching that which artists are skilled in playing the piano or who have played piano in the artist music instrument relation 13419. The result is then transmitted to the client server 3. The information of the artists who have been reported by tabloids as being involved in a relationship and being related to other system-defined types of relationships with the other artists is stored in the system-defined artist relation 13420. When the user inputs “Artist G”, the determination unit 15 makes the decision of searching the artists who have been reported by tabloids as being involved in a relationship and be relative to, or other types of relationships with “Artist G”. The result is then transmitted to the client server 3. The communication artist relation 13421 is a community relation of the user with at least one other user, e.g., a community relation with a friend, a relative or a classmate. When the user inputs “Artist H”, the determination unit 15 makes the decision of searching the songs performed by “Artist H” in the community artist relation 13421. The songs were searched first according to the song request signal, “Artist H”, and secondly referring to the song request history information 1333 from the friend, the relative or the classmate of the user. In addition, the songs are listed from the top according to the at least one of other users having a highest level of interaction with the user. The user could define the relationship to the artists and then the user-defined relationship is stored the user-defined relationship in the user-defined artist relation 13422. When the user inputs a song request signal, the determination unit 15 makes the decision of searching the information stored in the user-defined artist relationship 13422. The songs or the artists are searched and listed based on the user-defined relationship defined by the user. The result list of songs or artists is transmitted to client server 3. The information of artists whose songs have previously requested by the user is stored in the user artist song request history 13423. The data of previously requested songs performed by the artists should refer to the user's the user song request history information 1333.When the user inputs a song request signal, “Artist I”, the determination unit 15 makes the decision of searching songs of “Artist I” which have been previously requested. The result of the song list is transmitted to client server 3. It should be noted that, in order to access the communication artist relation 13421, the user-defined artist relation 13422 and the user artist song request history 13423, the user first needs to log into the characteristic karaoke VOD system.

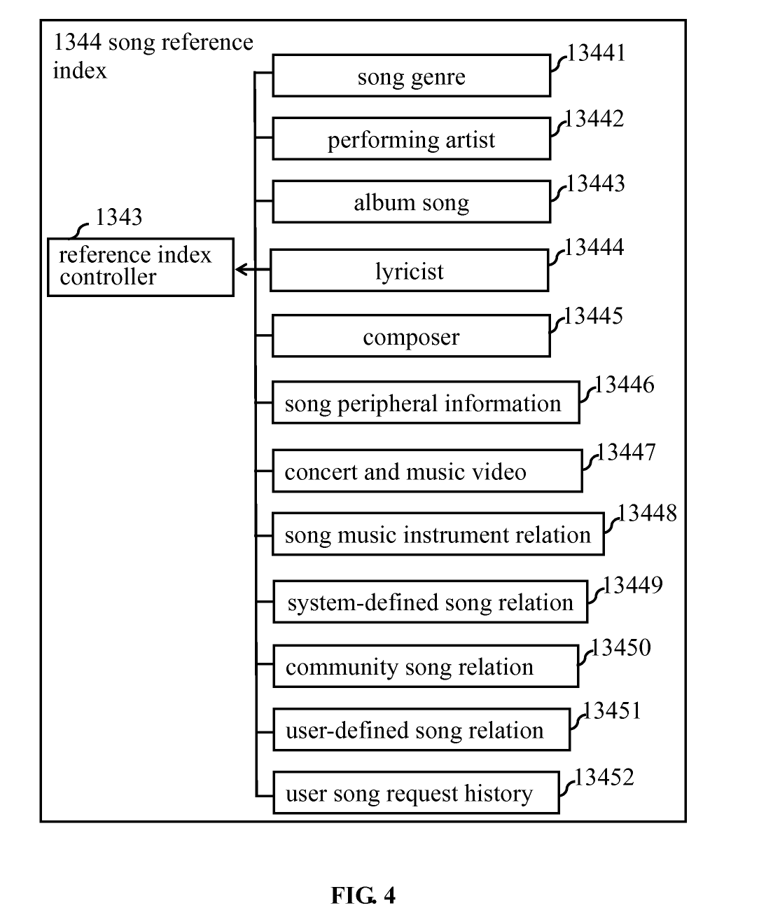

Referring to FIG. 4, the song reference index comprises a reference index controller 1343, a song genre 13441, a performing artist 13442, an album song 13443, a lyricist 13444, a composer 13445, a song peripheral information 13446, a concert and music video 13447, a song music instrument relation 13448, a system-defined song relation 13449, a community song relation 13450, a user-defined song relation 13451 and/or a user song request history 13452. The song reference index 1344 comprising the reference index controller 1343 serves as a control and transceiving interface and is connected to the remote CPU 11. The reference index controller 1343 is further connected to the song genre 13441, the performing artist 13442, the album song 13443, the lyricist 13444, the composer 13445, the song peripheral information 13446, the concert and music video 13447, the song music instrument relation 13448, the system-defined song relation 13449, the community song relation 13450, the user-defined song relation 13451 and the user song request history 13452.

The information of songs grouped into a same group based on the same type of music, the same genre, is stored in the song genre 13441. The genre of songs could comprise soul/R&B, country, rock, rap/hip-hop, etc. When the user inputs a song belonged to R&B, the determination unit 15 makes the decision of searching the information stored in the song genre 13441. Other songs grouped into R&B were searched and selected. The result of the song list is transmitted to client server 3. The information of songs performed by the same artist is stored in the performing artist 13442. When the user inputs a song named A, the determination unit 15 makes the decision of searching the other songs performed by the same artist of song A in the performing artist 13442. The result of the song list is transmitted to client server 3. The information of songs included in an album is stored in the album song 13443. When the user inputs a song named B, the determination unit 15 makes the decision of searching the other songs in the same album with song B in the album song 13443. The result of the song list is transmitted to client server 3. The information of the lyricist of a song is stored in the lyricist 13444. When the user inputs a song named C, the determination unit 15 makes the decision of searching the other songs written by the same lyricist of song C in the lyricist 13444. A song most frequently or most recently requested is listed from the top. The result of the song list is transmitted to client server 3. The information of the composer of a song is stored in the composer 13445. When the user inputs a song named D, the determination unit 15 makes the decision of searching the other songs written by the same composer of song D in the composer 13445. A song most frequently or most recently requested being listed from the top. The result of the song list is transmitted to client server 3. A song's peripheral information comprising products, brands, activities, programs and movies, is stored in the song peripheral information 13446. When the user inputs a name of the brand, the determination unit 15 makes the decision of searching the theme songs or songs which are related to the brand inputted by the user in the song peripheral information 13446. The result of the song list is transmitted to client server 3. The information about songs in a concert and the information of a song comprising the information indicating to other songs are stored in the concert and music video 13447. When the user inputs one song named E, the determination unit 15 makes the decision of searching the other songs which have been performed in the same concert with song E and searching other music videos whose names have shown in the lyrics of song E in the concert and music video 13447. The result of song list is transmitted to client server 3. The information of songs which are played on instruments is stored in the song music instrument relation 13448. When a user inputs “piano” as the song request signal, the determination unit 15 makes the decision of searching songs which are played on piano, music videos in which a piano has shown, or songs with piano in the chorus of the songs in the song music instrument relation 13448. The result of the song list is transmitted to the client server 3. The information about system-defined relationship is stored in the system-defined song relation 13449. For example, when the user inputs an artist L as the request song signal, the determination unit 15 makes the decision of searching songs performed by other artists who were reported by tabloids that the artists are involved in an affair with artist L or relatives to the artist L. The inputted song request signal is not limited by the name of the artist. The result of song list is transmitted to the client server 3. The information about songs which have been requested by at least one of the other users is stored in the community song relation 13450. When the user inputs one song named F, the determination unit 15 makes the decision of searching other songs which were requested with song F by the at least one of the other users in the community song relation 13450. The requested songs of the at least one of other users in the community song relation 13450 are referred to other users' the user song request history information 1333. Songs from the at least one of other users who has interacted with the user most in the VOD system are listed from the top. The result of song list is transmitted to the client server 3. The relationships between songs can be defined by the user and then stored in the user-defined song relation 13451. When a user inputs a song request signal, the determination unit 15 makes the decision of searching songs or artists in the user-defined song relation 13451. The recommended results are transmitted to the client server 3. The information of other songs also previously requested by the user is stored in the user song request song history 13452. The previously requested songs of the user refer to the user's the user song request history information 1333. When the user inputs a song named G, the determination unit 15 makes the decision of searching other songs which was previously requested with song G The result of the song list is transmitted to the client server 3. In order to access the community song relation 13450, the user-defined song relation 13451 and the user song request history 13452, the user needs to first log into the characteristic karaoke VOD system.

The client server 3 comprises a client CPU 31, an input device 32, a display unit 33 and a client communication unit 34. The client CPU 31 controls and processes a received signal. The input device 32 is connected to the client CPU 31, and inputs the song request signal. For example, the input device 32 is a portable device, a remote controller, a keyboard or a mouse. The display unit 33 is connected to the client CPU 31, and displays a song request image. The client communication unit 34 is connected to the client CPU 3 1 and is connected to the remote server 1 via the network 2, and serves as a data transceiving and communication interface.

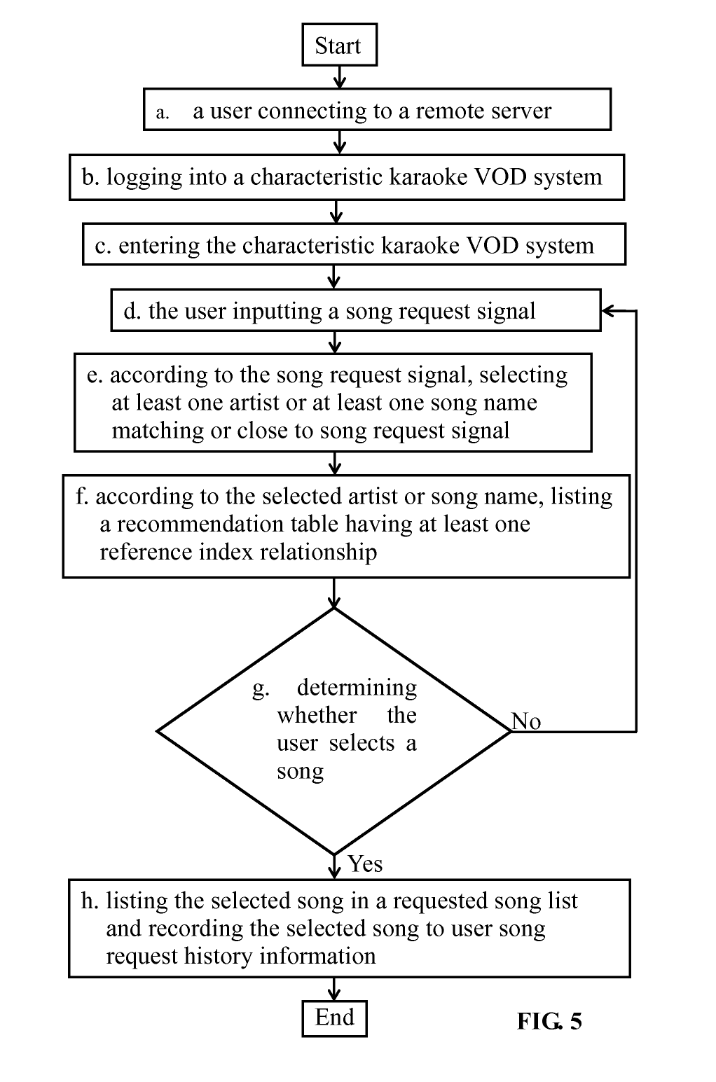

FIG. 5 shows a flowchart of an operating process of a characteristic karaoke VOD system.

The operating process comprises steps of: a) a user connecting to a remote server 1; b) logging into a characteristic karaoke VOD system; c) entering the characteristic karaoke VOD system; d) the user inputting a song request signal; e) according to the song request signal, selecting at least one artist or at least one song name matching or close to the song request signal; wherein, in a process of inputting the song request signal, the at least one artist or the at least one song name is listed according to at least one phonetic symbol or at least one universal symbol inputted; f) according to the selected artist or a song name, listing a recommendation table having at least one reference index relationship; g) determining whether the user selects a song or not, if the user selects a song, then performing step (h), or else, performing step (d); and h) listing the selected song in a requested song list and recording the selected song to user song request history information 1333.

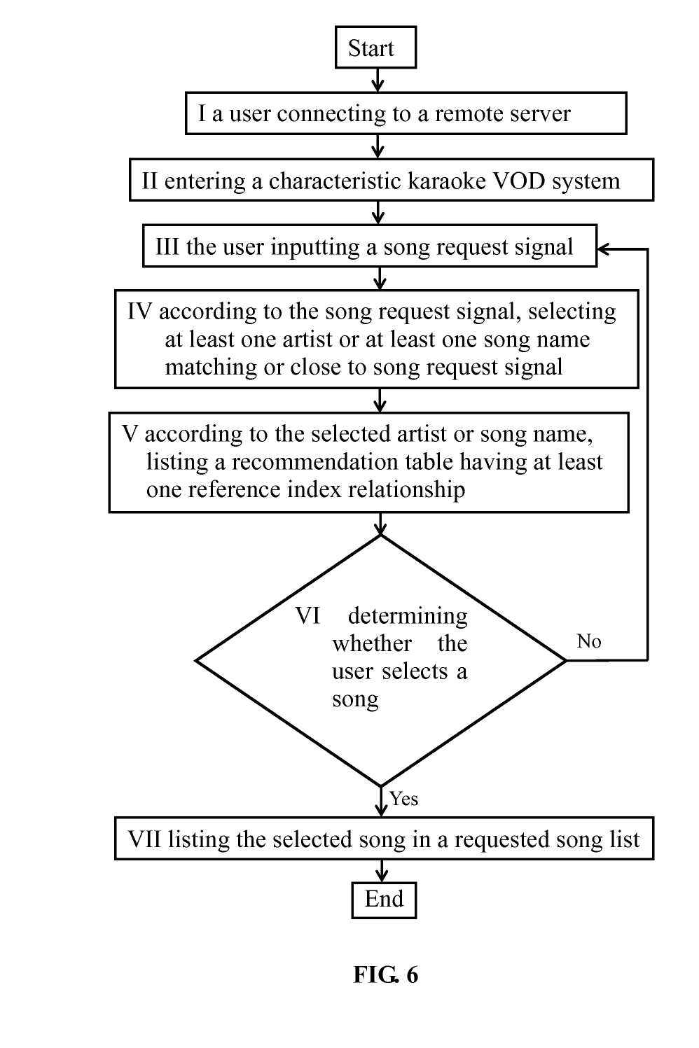

FIG. 6 shows a flowchart of an operating process of a characteristic karaoke VOD system according to another embodiment of the present invention.

The operating process comprises steps of: I) a user connecting to a remote server 1; II) entering the characteristic karaoke VOD system; III) the user inputting a song request signal; IV) according to the song request signal, selecting at least one artist or at least one song name matching or close to the song request signal; wherein, in a process of inputting the song request signal, the at least one artist or the at least one song name is listed according to at least one phonetic symbol or at least one universal symbol inputted; V) according to a selected artist or a song name, listing a recommendation table having at least one reference index relationship; VI) determining whether the user selects a song or not, if the user does so, performing step (VII), or else performing step (III); and VII) listing the selected song in a requested song list.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A characteristic karaoke video-on-demand (VOD) system, comprising:
a client server; and
a remote server, comprising:
a remote central processing unit (CPU);
a remote communication unit, connected to the remote CPU;
a verification unit, connected to the remote CPU;
an application program processing unit, connected to the remote CPU;
a determination unit, connected to the remote CPU; and
a storage unit, comprising a reference index database, a character/symbol database, a song database and a user database, all being connected to the remote CPU;
wherein, the remote server is connected to the client server by the remote communication unit via a network.

2. The system according to claim 1, wherein the client server is a network-connectable device comprising a network television, a set-up-box network television, a smart phone or a personal computer.

3. The system according to claim 1, wherein the client server comprises:
a client CPU;
an input device, connected to the client CPU;
a display unit, connected to the client CPU; and
a client communication unit, connected to the client CPU;
wherein, the client server is connected to the remote server by the client communication unit via the network.

4. The system according to claim 3, wherein the input device is a portable device, a keyboard, a mouse or a remote controller.

5. The system according to claim 1, wherein the reference index database comprising an artist reference index and a song reference index is connected to the remote CPU.

6. The system according to claim 5, wherein the artist reference index comprises a reference index controller, an artist genre, a choral artist, a choral song, a rank of requested songs, a released album, a latest song, an artist peripheral information, an artist concert and music video, an artist music instrument relation, a system-defined artist relation, a community artist relation, a user-defined artist relation and/or a user's requested song history; the reference index controller serving as a control and transceiving interface, connected to the remote CPU, as well as the artist genre, the choral artist, the choral song, the rank of requested songs, the released album, the latest song, the artist peripheral information, the artist concert and music video, the artist music instrument relation, the system-defined artist relation, the community artist relation, the user-defined artist relation and the user's requested song history.

7. The system according to claim 5, wherein the song reference index comprises the reference index controller, a song genre, a performing artist, an album song, a lyricist, a composer, a song peripheral information, a concert and music video, a song music instrument relation, a system-defined song relation, a community song relation, a user-defined song relation and/or a user song request history; the song reference index comprising the reference index controller serving as a control and transceiving interface, connected to the remote CPU; the reference index controller further connected to the song genre, the performing artist, the album song, the lyricist, the composer, the song peripheral information, the concert and music video, the song music instrument relation, the system-defined song relation, the community song relation, the user-defined song relation and the user song requested history.

8. The system according to claim 1, wherein the character/symbol database comprises a phonetic symbol database, a universal symbol database and/or a synonym database.

9. The system according to claim 8, wherein the universal symbol database stores traditional Chinese, simplified Chinese, English alphabet, Japanese hiragana, Japanese katakana, Korean and/or Roman symbols.

10. The system according to claim 8, wherein the synonym database comprises user-defined meaning of a word according to a user utilization habit.

11. The system according to claim 1, wherein the user database comprises a database controller, a user basic information, a user song request history information and a user community relation information; the database controller serving as a control and a transceiving interface, connected to the user basic information, the user song request history information, the user community relation information and the remote CPU.

12. An operating process of a characteristic karaoke video-on-demand (VOD) system, comprising:
a) a user connecting to a remote server;
b) logging into a characteristic karaoke VOD system;
c) entering the characteristic karaoke VOD system;
d) the user inputting a song request signal;
e) according to the song request signal, selecting at least one artist or at least one song name matching or close to the song request signal;
f) according to the selected artist or song name, listing a recommendation table having at least one reference index relationship;
g) determining whether the user selects a song, if the user selects a song, performing step (h);or else, performing step (d); and
h) listing the selected song in a requested song list, and recording the selected song to user song request history information.

13. The process according to claim 12, wherein the song request signal in the step (d) comprises at least one phonetic symbol or at least one universal character.

14. The process according to claim 12, wherein the step (f) selects the artist or the song name according to the at least one artist or the at least one song name in the step (e).

15. The process according to claim 12, wherein the reference index in the step (f) comprises an artist reference index and a song reference index.

16. The process according to claim 15, wherein the artist reference index comprises a reference index controller, an artist genre, a choral artist, a choral song, a rank of requested songs, a released album, a latest song, an artist peripheral information, an artist concert and music video, an artist music instrument relation, a system-defined artist relation, a community artist relation, a user-defined artist relation and/or a user's requested song history.

17. The process according to claim 15, wherein the song reference index comprises a reference index controller, a song genre, a performing artist, an album song, a lyricist, a composer, a song peripheral information, a concert and music video, a song music instrument relation, a system-defined song relation, a community song relation, a user-defined song relation and/or a user song request history.

18. An operating process of a characteristic karaoke video-on-demand (VOD) system, comprising:
I) a user connecting to a remote server;
II) entering the characteristic karaoke VOD system;
III) the user inputting a song request signal;
IV) according to the song request signal, selecting at least one artist or at least one song name matching or close to the song request signal;
V) according to the selected artist or song name, listing a recommendation table having at least one reference index relationship;
VI) determining whether the user selects a song, if the user selects a song performing step (VII), or else performing step (III); and
VII) listing the selected song in a requested song list.

19. The process according to claim 18, wherein the song request signal in the step (III) comprises at least one phonetic symbol or at least one universal character.

20. The process according to claim 18, wherein the step (V) selects the artist or the song name according to the at least one artist or the at least one song name in the step (IV).

21. The process according to claim 18, wherein the reference index in the step (V) comprises an artist reference index and a song reference index.

22. The process according to claim 21, wherein the artist reference index comprises a reference index controller, an artist genre, a choral artist, a choral song, a rank of requested songs, a released album, a latest song, an artist peripheral information, an artist concert and music video, an artist music instrument relation and/or a system-defined artist relation.

23. The process according to claim 21, wherein the song reference index comprises a reference index controller, a song genre, a performing artist, an album song, a lyricist, a composer, a song peripheral information, a concert and music video, a song music instrument relation and/or a system-defined song relation.
